(19) United States
(12) Patent Application Publication
(10) Pub. No.: US 2009/0305013 A1
(43) Pub. Date: Dec. 10, 2009

(54) LAYERED STRUCTURE COMPRISING NANOPARTICLES

(75) Inventors: Christy De Meyer, Waregem (BE); Sergey Lapshin, Gent (BE); Robrecht Moerkerke, Kortrijk (BE); Peter Persoone, Deinze (BE); Jan Vaneecke, Gits (BE)

Correspondence Address: FOLEY AND LARDNER LLP;SUITE 500, 3000 K STREET NW, WASHINGTON, DC, 20007, US

(73) Assignee: NV BERKAERT SA

(21) Appl. No.: 12/523,376

(22) PCT Filed: Feb. 21, 2008
(86) PCT No.: PCT/EP08/52152

§ 371 Date: Jul. 16, 2009

(30) Foreign Application Priority Data
Feb. 26, 2007 (EP) 07103056.3

(51) Int. Cl. B32B 7/02; B29C 47/00

(52) U.S. Cl. 428/212; 264/171.1

(57) ABSTRACT

The invention relates to a layered structure comprising at least a first and a second layer whereby the refractive indices of the first and the second layer are matched to avoid iridescence by adding nanoparticles to at least one of the first or the second layer. The invention also relates to a window film comprising a substrate and a low iridescent coating. The invention further relates to a method to match the index of refractive indices of two layers thereby avoiding iridescence.

### TECHNICAL FIELD

The invention relates to a layered structure comprising at least a first and a second layer whereby the refractive indices of the first and the second layer are matched to avoid iridescence. The invention also relates to a window film comprising a substrate and a low iridescent coating. The invention further relates to a method to match the index of refractive indices of two layers thereby avoiding iridescence.

### BACKGROUND ART

Window films such as solar control films and safety films are known in the art. These window films comprise a polymer substrate provided with one or more layers for example to absorb or reflect infrared radiation.

However, a problem associated with this type of films having low thickness is the occurrence of iridescence. Iridescence is known as an optical phenomenon showing interference colors in reflected light and to a lesser extend in transmitted light. The iridescence phenomenon is most pronounced using artificial light and more particular using fluorescent light.

### DISCLOSURE OF INVENTION

It is an object of the present invention to provide a layered structure comprising at least a first and a second layer whereby the refractive indices of the first and the second layer are matched.

It is another object to provide a layered structure avoiding the occurrence of iridescence.

It is a further object of the present invention to provide a window film comprising a substrate and coating avoiding the occurrence of iridescence.

It is still a further object of the present invention to provide a method to match the index of refractive indices of two layers thereby avoiding the occurrence of iridescence.

According to a first aspect of the present invention a layered structure comprising at least a first layer having a refractive index η₁ and a second layer having a refractive index η₂ whereby the refractive indices of the first layer η₁ and the refractive index of the second layer η₂ are matched is provided.

The first layer comprises a first matrix material having a refractive index η_{matrix 1} and the second layer comprises a second matrix material having a refractive index η_{matrix 2}. The refractive index of the first matrix material η_{matrix 1} is different from the refractive index of the second matrix material η_{matrix 2}. The difference between the refractive index of the first matrix material η_{matrix 1} and the refractive index of the second matrix material η_{matrix 2} at a wavelength of 510 nm being at least 0.1.

The layered structure is characterised in that at least one of the first layer or the second layer comprises nanoparticles to match the difference in refractive index between the first matrix material η_{matrix 1} and the second matrix material η_{matrix 2} in such a way that the difference between the refractive index of the first layer η₁ and the refractive index of the second layer η₂ at each wavelength of the visible range is less than 0.08. For the purpose of this invention, the visible range is defined as the range between 380 and 750 nm.

In a preferred embodiment the difference between the refractive index of the first matrix material η_{matrix 1} and the refractive index of the second matrix material η_{matrix 2} at a wavelength of 510 nm is higher than 0.12, for example higher than 0.15.

As mentioned above the difference in refractive index of the first layer η₁ and the refractive index of the second layer η₂ at each wavelength in the visible range is lower than 0.8. More preferably, the difference in refractive index of the first layer η₁ and the refractive index of the second layer η₂ at each wavelength in the visible range is lower than 0.6 and most preferably lower than 0.05 or even lower than 0.02.

By using nanoparticles to match the refractive index of the first layer and the second layer, the optical properties of the layered structure such as clarity and haze are not influenced or are only influenced to a very low extent.

In a first embodiment either the first layer or the second layer comprises nanoparticles. In an alternative embodiment both the first and the second layer comprises nanoparticles.

For the purpose of this invention nanoparticles are defined as particles having a diameter ranging between 1 and 500 nm. More preferably, the diameter of the particles range between 10 and 100 nm, for example between 20 and 80 nm.

The nanoparticles may have any shape. They can for example have a spherical, elongated, cubic, ellipsoidal or any other regular or irregular shape. The nanoparticles can be amorphous, semi-amorphous or crystalline.

The nanoparticles may comprise either organic or inorganic nanoparticles. Example of organic nanoparticles are carbon nanotubes or nanospheres. Examples of inorganic particles are oxide particles, sulphide particles and nitride particles.

The oxide particles are preferably selected from the group consisting of aluminum oxide, silicon oxide, zirconium oxide, titanium oxide, antimony oxide, zinc oxide, tin oxide, indium oxide, indium tin oxide, cerium oxide, niobium oxide, vanadium oxide, tungsten oxide, tantalium oxide, doped oxides and mixtures of one or more of these oxides. Doped oxides comprise for example doped indium oxide such as indium oxide doped with tin, doped vanadium oxide, doped tungsten oxide.

Sulphide particles comprise for example zinc sulphide.

Nitride particles comprise for example silicon nitride.

It can be preferred to use a mixture of two or more nanoparticles. By using different types of nanoparticles the difference in refractive index between the first layer and the second layer can be better matched over a broader wavelength range. A preferred mixture of nanoparticles comprises a combination of titanium oxide and zirconium oxide particles.

The refractive index of the first layer and of the second layer is influenced by the refractive index of the matrix material, the refractive index of the nanoparticles, the volume fraction of the nanoparticles, the volume fraction of the matrix material, the size and shape of the nanoparticles, . . .

For the purpose of this invention, the volume fraction of nanoparticles of a layer is defined as the volume of the nanoparticles present in the layer divided by the total volume of the layer. In case voids are present in the layer, these voids are included in the total volume of the layer.

The volume fraction of the matrix material is defined as the volume of the matrix material present in the layer divided by the total volume of the layer.

The matrix material comprises for example a binder such as an inorganic or an organic binder or a resin. As an example of inorganic binders silicate binders can be considered. As organic binder acrylic based binders, vinyl based binders, urethane based binders and the like can be considered.

Possibly, one or more additives are added to the matrix material. Examples of additives comprise surface control agents, foam control agents, rheology modifiers, dispersants, wetting agents, color tone adjustment agents, surface modifiers, cure initiators such as UV cure initiators or electron beam cure initiators, thermal cure initiators, anti-shining agents, corrosion inhibitors, conductivity agents, UV absorbers, light stabilizers, biocides, adhesion promoters, polymerization initiators, solar control additives such as nanoparticles for example indium tin oxide (ITO) nanoparticles or antimony tin oxide (ATO) nanoparticles, . . .

According to the present invention the concentration of nanoparticles of the low iridescent coating is chosen in such a way that the refractive index of the low iridescent coating approximates the refractive index of the substrate.

In case one type of nanoparticles is used, the refractive index of layer n at a certain wavelength λ is calculated according to the following equation:

η_{layer n}(λ)=V_{NP}·η_{NP}(λ)+Vₘₐₜᵣᵢₓ·ηₘₐₜᵣᵢₓ(λ)

whereby
η_{layer n}(λ) is the refractive index of layer n at wavelength λ;
V_{NP} is the volume fraction of the nanoparticles in layer n;
η_{NP}(λ) is the refractive index of the nanoparticles at the wavelength λ;
Vₘₐₜᵣᵢₓ is the volume fraction of the matrix material in layer n;
ηₘₐₜᵣᵢₓ(λ) is the refractive index of the matrix material at the wavelength λ.

In case a mixture of different types of nanoparticles is used, the refractive index of layer n at a certain wavelength λ is calculated according to the following equation:

η_{layer n}(λ)=V_{NP}_{₁}·η_{NP}_{₁}(λ)+V_{NP}_{₂}·η_{NP}_{₂}(λ)+ . . . +V_{NP}_{ₙ}·η_{NP}_{ₙ}(λ)+Vₘₐₜᵣᵢₓ·ηₘₐₜᵣᵢₓ(λ)

whereby
η_{NP1}(λ) is the refractive index of the first type of nanoparticles at the wavelength λ;
V_{NP1} is the volume fraction of the first type of nanoparticles in layer n;
η_{NP2}(λ) is the refractive index of the second type of nanoparticles at the wavelength λ;
V_{NP2} is the volume fraction of the second type of nanoparticles in layer n;
η_{NPn}(λ) is the refractive index of the n^{th} type of nanoparticles at the wavelength λ.
V_{NPn} is the volume fraction of the n^{th} type of nanoparticles in layer n.

According to the present invention the nanoparticles are incorporated or embedded in the matrix material. Any method to incorporate or embed the nanoparticles in the matrix material can be used. One possible method comprises extrusion or coextrusion. Alternatively, the layer comprising the matrix material and the nanoparticles can be obtained by applying a mixture comprising the matrix material and the nanoparticles on a substrate. This mixture can be applied by any technique known in the art, preferably by a wet coating technique. Suitable techniques are self-metered coating techniques as spin coating, dip coating, reverse roll coating, reverse roll precision coating, direct roll coating, nip roll coating and forward roll coating; doctored coating techniques as meyer rod coating, blade coating, knife coating, air-knife coating, kiss coating; pre-metered coating techniques as slot die coating, slide coating, extrusion coating, curtain coating, curtain precision coating, spray coating or hybrid coating techniques using a combination of one or more of the above mentioned techniques such as gravure coating, microgravure coating and meniscus coating. Possibly, a solvent is added to the mixture.

In a specific embodiment of the present invention, the nanoparticles comprise organic groups on their surface. These organic group may form a crosslinked network with the matrix material. These organic groups are for example grafted to the nanoparticle surface. Examples may be nanoparticles with acrylate groups and/or methacrylate groups.

The layered structure according to the present invention is of particular importance in case one of the layers of the layered structure has a thickness lower than 5 μm as for example between 1 and 3.5 μm. It is known in the art that iridescence is most pronounced in case such thin layers are used.

According to a second aspect of the present invention a window film comprising a layered structure comprising at least a first layer and a second layer as described above is provided.

The window film can for example function as a solar control film or as a safety film.

Preferably, at least one of the first layer and the second layer comprises a substrate. As substrate in principle any substrate can be considered as for example a transparent substrate, a dyed substrate, a reflecting substrate and an absorbing substrate. The substrate can either be flexible or rigid. Preferred substrates comprise glass substrates and polymer films. Suitable polymers comprise polycarbonate resins, acrylic resins, polyester resins, polyethylene terephthalate resins, polyethylene naphthalate resins, polyamide resins, vinyl chloride resins, olefin resins, epoxy resins, polyimide resins, fluoro resins, vinyl based resins, such as polyvinylbutyral resins or ethylene acetic acid vinyl copolymer resins, polyurethane resins and polyetherimide resins.

Preferably, at least one of the first layer and the second layer comprises a coating layer applied on a substrate.

A coating layer according to the present invention has preferably a thickness lower than 5 μm, as for example between 1 and 3.5 μm.

In case the layered structure or the window film comprises a coating layer, the refractive index of the coating layer is the refractive index of the coating layer as such.

A first group of window films comprises window films comprising a layered structure having as first layer a substrate and as second layer a coating layer applied on this substrate. The coating layer may for example have the function of a hard coating, an adhesive layer, an infrared absorbing layer, an anti-fog layer, . . . The coating layer comprises nanoparticles to match the refractive index of the coating layer to the refractive index of the substrate.

In a particular embodiment of this first group of window films, the window film comprises a substrate and a hard coating. The hard coating comprises for example an acrylate based coating layer. The hard coating comprises nanoparticles. The volume fraction of the nanoparticles in the hard coating is chosen in such a way that the difference between refractive index of the hard coating comprising the nanoparticles and the refractive index of the metallized substrate at each wavelength of the visible range is less than 0.08, more preferably less than 0.06 and most preferably even less than 0.02. As the refractive index of the hard coating is matched to the refractive index of the substrate, this type of window film does not show iridescence.

This type of window film can be adhered to a glass substrate by means of an adhesive layer. As the refractive index of the adhesive layer and the glass substrate are different, iridescence may occur at the interface adhesive—glass substrate. To avoid this, possibly nanoparticles can be added to the adhesive layer to match the difference in refractive index of the adhesive layer and the glass substrate.

A second group of window films comprises a metallized substrate and a coating layer as for example a hard coating. The metallized substrate comprises for example a polymer or a glass substrate provided with a metal layer such as a silver layer. The hard coating comprises nanoparticles. The volume fraction of the nanoparticles in the hard coating is chosen in such a way that the difference between refractive index of the hard coating comprising the nanoparticles and the refractive index of the metallized substrate at each wavelength of the visible range is less than 0.08, more preferably less than 0.06 and most preferably even less than 0.02. As the refractive index of the hard coating is matched to the refractive index of the substrate, this type of window film does not show iridescence.

Also this type of window film can be adhered to a glass substrate by means of an adhesive layer. Possibly nanoparticles can be added to the adhesive layer to match the difference in refractive index of the adhesive layer and the glass substrate.

A third group of window films comprises at least a first substrate and a second substrate. The window films comprises consecutively a first substrate, an adhesive layer, a second substrate and a hard coating. The hard coating comprises nanoparticles to match the refractive index of the hard coating to the refractive index of the second substrate and to avoid iridescence. The volume fraction of the nanoparticles in the hard coating is chosen in such a way that the difference between the refractive index of the hard coating and the refractive index of the second substrate at each wavelength of the visible range is less than 0.08, more preferably less than 0.06 and most preferably even less than 0.02.

Possibly, nanoparticles are also added to the adhesive layer to match the refractive index of the adhesive layer to the refractive index of the first substrate.

Also this type of window film can be adhered to a glass substrate by means of an adhesive layer. Possibly, nanoparticles can be added to the adhesive layer to match the difference in refractive index of the adhesive layer and the glass substrate.

According to a third aspect of the present invention a method to match the difference in refractive index between a first layer and a second layer is provided. The first layer has a refractive index η₁. The second layer has a refractive index η₂. The first layer comprises a first matrix having a refractive index nₘₐₜᵣᵢₓ₁ and the second layer comprises a second matrix material having a refractive index nₘₐₜᵣᵢₓ₂. The refractive index nₘₐₜᵣᵢₓ₁ is different from the refractive index nₘₐₜᵣᵢₓ₂. The difference between the refractive index nₘₐₜᵣᵢₓ₁ and the refractive index nₘₐₜᵣᵢₓ₂ at a wavelength of 510 nm being at least 0.1.

The method according to the present invention comprises the step of incorporating nanoparticles in at least one of said first and/or said second matrix material. The volume fraction of said nanoparticles in said first and/or said second matrix material is chosen to obtain a difference in refractive index of the first layer n₁ and of the second layer index n₂ less than 0.08.

More preferably, the difference in refractive index of the refractive index n₁ and of the second layer index n₂ less than 0.06 or even lower than 0.02.

### BRIEF DESCRIPTION OF FIGURES IN THE DRAWINGS

The invention will now be described into more detail with reference to the accompanying drawings wherein

FIG. 1 is an illustration of a reflection spectrum in the visible range of a substrate having a coating layer whereby the substrate and the coating layer have a different refractive index;

FIG. 2 is an illustration of a reflection spectrum in the visible range of a substrate coated with a low iridescent coating according to the present invention;

FIG. 3 is an illustration of a reflection spectrum in the visible range of glass substrate provided with a window film.

### MODE(S) FOR CARRYING OUT THE INVENTION

The present invention will be further described with respect to particular embodiments and with reference to certain drawings.

The term first, second and the like in the description and the claims are used for distinguishing between similar elements and not necessarily for describing a sequence, either temporally, spatially, in ranking or in any other manner.

A first example of a coated substrate comprises a PET film coated with a hard coating. The hard coating comprises an acrylate based coating, more particularly a 95 wt % mixture of penta erythritol acrylates multifunctional monomers, 2 wt % additives and 3 wt % of UV cure initiators. The coating has a thickness ranging between 1.5 and 3 μm. The hard coating has a refractive index at 510 of 1.48. The PET film has a thickness of 23 μm and a refractive index at 510 nm of 1.65.

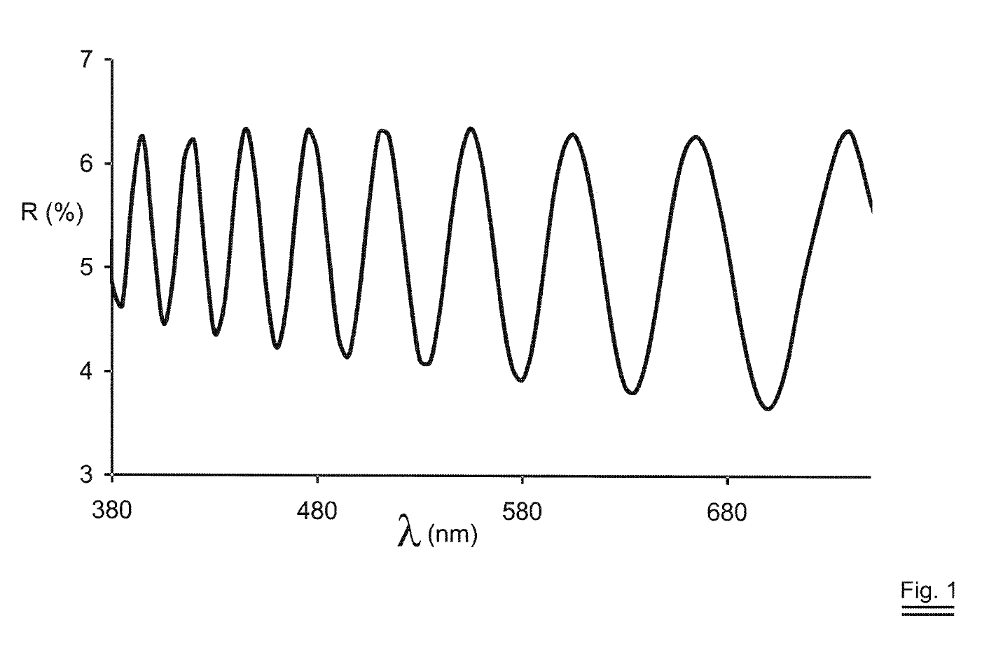

The reflection spectrum of this coated substrate is given in FIG. 1. The reflection pattern of FIG. 1 shows pronounced fringes in the visible range.

A second example comprises a substrate coated with hard coating layer according to the present invention. The hard coating comprises an acrylate based coating as mentioned in the first example having a thickness ranging between 1.5 and 3 μm. The substrate comprises a PET film having a thickness of 23 μm and having a refractive index at 510 nm of 1.65. The hard coating further comprise ZrO₂ nanoparticles. The concentration of ZrO₂ nanoparticles is chosen in order to match the difference in refractive index between the substrate and the hard coating.

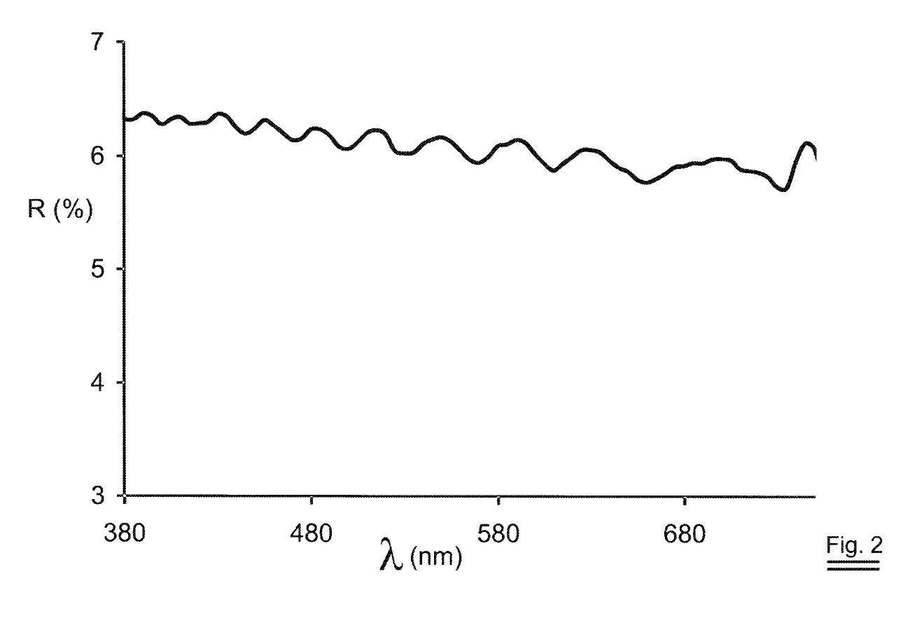

The reflection spectrum of this coated substrate is given in FIG. 2. Compared to FIG. 2, the fringes in the visible range are less pronounced resulting in a coated substrate showing no iridescence.

A third example comprises a glass substrate provided with a window film. The window film comprises a PET substrate and a hard coating comprising ZrO₂ particles. The window film is laminated to the glass substrate by means of an adhesive. The PET substrate has a thickness of 23 μm and the glass substrate is 3 mm clear glass. The hard coating comprises an acrylate based coating as mentioned in the first example.

Three different embodiments of window films are considered each having a different concentration of ZrO₂ particles:
a first embodiment A comprises a hard coating without added ZrO₂ particles;
a second embodiment B comprises a hard coating having a low volume fraction of ZrO₂ particles;
a third embodiment C comprises a hard coating having a volume fraction of ZrO₂ particles to match the difference in refractive index between the PET substrate and the hard coating.

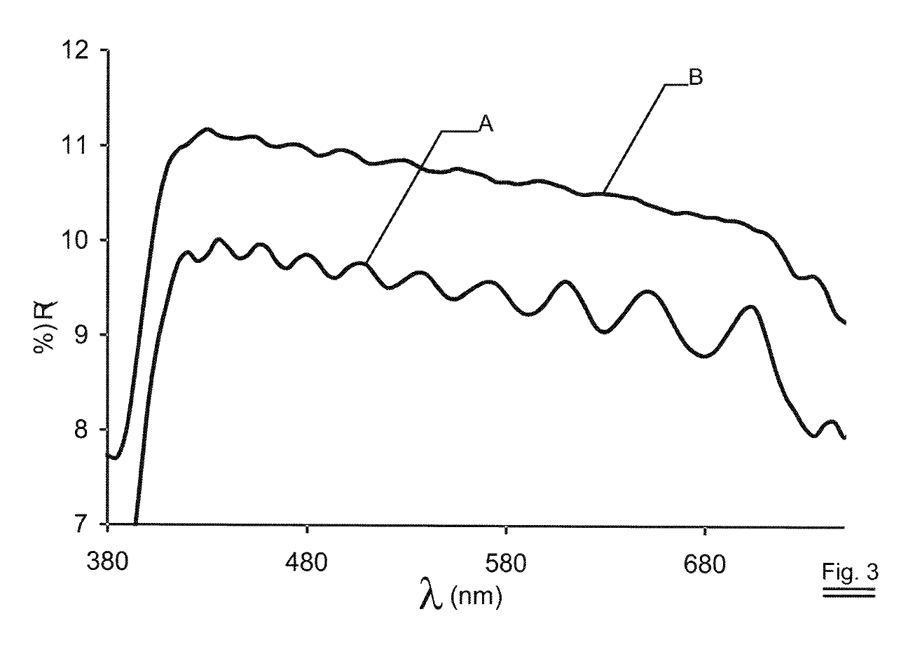

The reflection spectra of the glass provided with the three different embodiments of window films are given in FIG. 3.

From FIG. 3 it can be concluded that the fringes of the spectra are reduced by increasing the concentration of nanoparticles in the hard coating so that the difference in refractive index between the PET substrate and the hard coating is reduced.

1. A layered structure comprising at least a first layer having a refractive index η₁ and a second layer having a refractive index η₂, said first layer comprising a first matrix material having a refractive index η_{matrix 1} and said second layer comprising a second matrix material having a refractive index η_{matrix 2}, the difference between said refractive index of said first matrix material η_{matrix 1} and said refractive index of said second matrix material η_{matrix 2} at a wavelength of 510 nm being at least 0.1; characterised in that at least one of said first layer or said second layer comprises nanoparticles having a diameter ranging between 1 and 500 nm to match the difference in refractive index between the first matrix material η_{matrix 1} and the second matrix material η_{matrix 2} in such a way that the difference between the refractive index of the first layer η₁ and the refractive index of the second layer η₂ at each wavelength of the visible range from 380 to 750 nm is less than 0.08.

2. A layered structure according to claim 1, whereby said first layer and said second layer comprise nanoparticles.

3. A layered structure according to claim 1, whereby said nanoparticles comprise organic or inorganic nanoparticles or a combination of organic and inorganic nanoparticles.

4. A layered structure according to claim 1, whereby said nanoparticles are selected from the group consisting of oxides particles, sulphide particles, nitride particles, doped oxide particles, doped sulphide particles, doped nitride particles and combinations thereof.

5. A layered structure according to claim 4, whereby said nanoparticles are selected from the group consisting of aluminum oxide, silicon oxide, zirconium oxide, titanium oxide, antimony oxide, zinc oxide, tin oxide, indium oxide, indium tin oxide, cerium oxide, niobium oxide, vanadium oxide, tungsten oxide, tantalium oxide, zinc sulphide, silicon nitride, doped variants thereof and mixtures thereof.

6. A layered structure according to claim 1, whereby said nanoparticles comprise organic groups on their surface, said organic groups forming a crosslinked network with said matrix material.

7. A layered structure according to claim 6, whereby said organic groups comprises acrylate groups and/or methacrylate groups.

8. A layered structure according to claim 1, whereby at least one of said first layer or said second layer comprises a layer having a thickness lower than 5 μm.

9. A window film comprising a layered structure comprising at least a first layer and a second layer as defined in claim 1.

10. A window film according to claim 9, functioning as a solar control film or as a safety film.

11. A window film according to claim 9, whereby at least one of said first layer and said second layer comprises a glass substrate or a polymer substrate.

12. A window film according to claim 9, whereby at least one of said first and said second layer comprises a coating layer.

13. A window film according to claim 9, whereby said first and/or said second layer has a thickness lower than 5 μm.

14. A window film according to claim 9, whereby said first layer comprises a polymer substrate or a glass substrate and whereby said second layer comprises a coating layer applied on said first layer, said second layer comprising nanoparticles.

15. A window film according to claim 14, whereby said coating layer is functioning as a hard coating, an adhesive, an infrared absorbing layer or an anti-fog layer.

16. A method to match the difference in refractive index between a first layer having a refractive index n₁ and a second layer having a refractive index η₂; said first layer comprising a first matrix material having a refractive index nₘₐₜᵣᵢₓ₁ and said second layer comprising a second matrix material having a refractive index nₘₐₜᵣᵢₓ₂, the difference between said refractive index nₘₐₜᵣᵢₓ₁ and said refractive index nₘₐₜᵣᵢₓ₂ at a wavelength of 510 nm being at least 0.1, said method comprises the step of incorporating nanoparticles in at least one of said first or said second matrix material, whereby said nanoparticles are present in a volume fraction that the difference in refractive index at each wavelength of the visible range from 380 nm to 750 nm is less than 0.08.

17. A method according to claim 16, whereby said first layer and said second layer comprise nanoparticles.

18. A method according to claim 16, whereby said nanoparticles comprise organic or inorganic nanoparticles or a combination of organic and inorganic nanoparticles.

19. A method according to claim 16, whereby said nanoparticles are selected from the group consisting of oxides particles, sulphide particles, nitride particles, doped oxide particles, doped sulphide particles, doped nitride particles and combinations thereof.

20. A method according to claim 16, whereby said nanoparticles are selected from the group consisting of aluminum oxide, silicon oxide, zirconium oxide, titanium oxide, antimony oxide, zinc oxide, tin oxide, indium oxide, indium tin oxide, cerium oxide, niobium oxide, vanadium oxide, tungsten oxide, tantalium oxide, zinc sulphide, silicon nitride, doped variants thereof and mixtures thereof.

21. A method according to claim 16, whereby at least one of said first layer or said second layer comprises a layer having a thickness lower than 5 μm.
